(19) United States
(12) Patent Application Publication
(10) Pub. No.: US 2005/0219442 A1
(43) Pub. Date: Oct. 6, 2005

(54) Color filter on array mode liquid crystal display and method for making the same

(75) Inventors: Chiu-Lien Yang, Miao-Li (TW); Sheng-Shiou Yeh, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/028,052

(22) Filed: Dec. 31, 2004

(30) Foreign Application Priority Data
Mar. 30, 2004 (TW) 93112184

(51) Int. Cl. G02F 1/1335

(52) U.S. Cl. 349/106

(57) ABSTRACT

A color filter on array mode liquid crystal display (100) includes a first substrate (110) and a second substrate (120) disposed opposite each other and spaced apart a predetermined distance, and a liquid crystal layer (130) interposed between the first substrate and the second substrate. A thin film transistor array (111), a color filter layer (112), and a plurality of pixel electrodes (114) are formed on the first substrate. A common electrode (124) is formed on the second substrate. A first polarizer (142) and a second polarizer (144) are positioned at the first substrate and the second substrate, respectively. The first polarizer is an extraordinary type polarizer. Therefore a good contrast ratio over wide viewing angles is achieved. In addition, the polarizers are made of a modified organic dye material which exists in a liquid-crystalline phase. Therefore the liquid crystal display can be applied in high temperature environments.

### BACKGROUND OF THE INVENTION

1. Field of the Invention

The present invention relates to color filter on array mode liquid crystal displays (COA-LCDs), and to methods for manufacturing COA-LCDs.

2. Description of Prior Art

In the field of color display terminals, thin film transistor liquid crystal display (TFT-LCD) technology is being developed as a possible successor to cathode ray tube technology. Liquid crystal displays with a given display screen viewing area occupy a much smaller volume than cathode ray tube devices with the same screen viewing area. This is considered commercially significant, since the smaller liquid crystal display has a smaller footprint; that is, the liquid crystal display occupies less area on a user's desk or computer enclosure. Liquid crystal display devices also have lower power requirements than corresponding cathode ray tube devices. In particular, the operating voltages of liquid crystal display devices are considerably lower than the operating voltages of cathode ray tube devices.

In a typical liquid crystal display device, there are two spaced-apart glass panels which define a sealed central cavity filled with a liquid crystal material. One of the glass panels is a thin film transistor (TFT) substrate, and the other glass panel is a color filter substrate. The liquid crystal display device has the disadvantage of a low aperture ratio. A COA-LCD is another type of LCD, which has the TFT and the color filter on the same substrate. The COA-LCD has a high aperture ratio and high brightness.

Referring to FIG. 4, a conventional COA-LCD 1 comprises an upper substrate 20 and a lower substrate 10 disposed opposite to each other and spaced apart a predetermined distance. A liquid crystal layer 30 having a multiplicity of liquid crystal molecules (not labeled) is disposed between the upper and lower substrates 20, 10. A backlight module (not shown) is disposed under the lower substrate 10, for providing illumination for the COA-LCD 1.

A TFT array 11 and a color filter layer 15 are positioned on an inner surface of the lower substrate 10, with the color filter layer 15 covering the TFT array 11. A plurality of pixel electrodes 13 are positioned on the color filter layer 15. An indium tin oxide (ITO) layer is positioned on an inner surface of the upper substrate 20 adjacent to the liquid crystal layer 30, the ITO layer functioning as a common electrode 22. Two polarizers 44, 42 are positioned on outer surfaces of the upper substrate 20 and the lower substrate 10, respectively. The polarizers 44, 42 are ordinary type polarizers, and are made of polyvinyl alcohol (PVA). The polarizers 44, 42 function to allow passage of ordinary polarized light beams, while blocking extraordinary polarized light beams. Polarizing axes of the polarizers 44, 42 are perpendicular to each other; that is, the polarizers 30, 40 are crossed polarizers.

When the COA-LCD 1 is driven, an electric field is formed between the common electrode 22 and the pixel electrodes 13 at each pixel. The liquid crystal molecules disposed between the counter electrode 11 and pixel electrodes 13 are all driven, thus giving the COA-LCD 1 displayed images.

However, light leakage occurs in an oblique viewing azimuth because of the crossed ordinary type polarizers 44, 42. The COA-LCD 1 has a high contrast ratio at a 0 degree (direct) viewing angle; however, the contrast ratio diminishes rapidly once the viewing angle changes from 0 degrees. The overall display quality of the COA-LCD 1 diminishes along with the diminution in the contrast ratio.

In addition, because the polarizers 42 and 44 are made of PVA, they cannot work at temperatures higher than 80 degrees Centigrade. This limits the kinds of application environments in which the COA-LCD 1 can be used. Furthermore, because the polarizers 42 and 44 are both positioned as outer surfaces of the COA-LCD 1, they are easily damaged or even destroyed in handling or in use. Moreover, in manufacturing of the COA-LCD 1, the polarizers 42 and 44 are typically separate parts having protecting films. In the last step of manufacturing, the polarizers 42 and 44 are adhered on the LCD panel. This makes the COA-LCD 1 unduly thick and bulky.

Further still, the color filter layer 15 has a de-polarizing effect on light beams passing therethrough, due to pigment light scattering. That is, light beams passing through the COA-LCD 1 are at least partially de-polarized by the color filter layer 15 before reaching the polarizer 44. This de-polarizing of the light beams can reduce the contrast ratio of the COA-LCD 1. Even though such de-polarizing effects are generally small, they can have a significant effect on the contrast ratio of the COA-LCD 1.

It is desired to provide a COA-LCD that can solve the above-mentioned problems.

### SUMMARY OF THE INVENTION

An object of the present invention is to provide a color filter on array mode liquid crystal display which achieves a good contrast ratio over wide viewing angles.

Another object of the present invention is to provide a color filter on array mode liquid crystal display which can work at high temperatures and which is relatively thin.

A further object of the present invention is to provide a method for manufacturing the above-described desired color filter on array mode liquid crystal display.

A color filter on array mode liquid crystal display of the present invention includes a first substrate and a second substrate disposed opposite each other and spaced apart a predetermined distance, and a liquid crystal layer interposed between the first substrate and the second substrate. A thin film transistor array, a color filter layer and a plurality of pixel electrodes are formed on the first substrate in turn. A common electrode is formed on the second substrate. An upper polarizer and a lower polarizer are positioned at the second substrate and the first substrate, respectively. The lower polarizer is an extraordinary type polarizer.

In a first embodiment, both of the polarizers are extraordinary type polarizers, which are arranged such that they are crossed polarizers. Leakage of light beams through the crossed polarizers is inversely proportional to the viewing angle. That is, light leakage at large viewing angles is reduced, and the polarizers provide a good contrast ratio over wide viewing angles.

In addition, the polarizers are made of a modified organic dye material which exists in a liquid-crystalline phase. Therefore the color filter on array mode liquid crystal display can work in temperatures less than 200 degrees Centigrade, and have a broader range of applications in the LCD marketplace. Furthermore, each polarizer has a thickness of less than 100 microns.

A method for manufacturing a color filter on array mode liquid crystal display of the present invention includes the steps of: (1) forming a TFT substrate, which includes the sub-steps of: providing a first substrate; forming a thin film transistor array on the first substrate; forming a color filter layer on the first substrate, the color filter layer covering the thin film transistor array; coating an indium tin oxide layer on the color filter layer, coating an extraordinary type polarizer layer on the indium tin oxide layer, and rubbing an alignment film on the extraordinary type polarizer layer; (2) forming a common electrode substrate, which includes the sub-steps of: providing a second substrate, coating an indium tin oxide layer on the second substrate; coating a second polarizer layer on the indium tin oxide layer; and rubbing an alignment film on the second polarizer layer; (3) adhering the first and second substrates together, thereby forming a liquid crystal cell; and (4) filling liquid crystal molecules into the liquid crystal cell.

Other objects, advantages, and novel features of the present invention will become more apparent from the following detailed description when taken in conjunction with the accompanying drawings, in which:

### BRIEF DESCRIPTION OF THE DRAWINGS

FIG. 1 is a schematic, side cross-sectional view of part of a COA-LCD according to a first embodiment of the present invention;

FIG. 2 is a schematic, side cross-sectional view of part of a COA-LCD according to a second embodiment of the present invention;

FIG. 3 is a schematic, side cross-sectional view of part of a COA-LCD according to a variation of the COA-LCD of FIG. 2; and

FIG. 4 is a schematic, side cross-sectional view of part of a conventional COA-LCD.

### DETAILED DESCRIPTION OF THE INVENTION

Referring to FIG. 1, a color filter on array mode liquid crystal display (COA-LCD) 100 according to the first embodiment of the present invention comprises a first substrate 110, a second substrate 120, and a liquid crystal layer 130 having a multiplicity of liquid crystal molecules (not labeled). A backlight module (not shown) is disposed under the first substrate 110. The first substrate 110 and the second substrate 120 are spaced apart from each other, and the liquid crystal layer 130 is disposed therebetween. The first substrate 110 and the second substrate 120 are made of glass. Alternatively, the first substrate 110 and the second substrate 120 can be made of silicon dioxide (SiO₂).

A TFT array 111 and a color filter layer 112 are positioned on an inner surface of the lower substrate 110, with the color filter layer 112 covering the TFT array 111. A plurality of pixel electrodes 114, a first polarizer 142 and a first alignment film 116 are positioned on the color filter layer 112, in that order from bottom to top. A common electrode 124 is positioned on an inner surface of the upper substrate 120. A second polarizer 144 and a second alignment film 126 are positioned on an underside of the common electrode 124, in that order from top to bottom.

The common electrode 124 is plate-shaped, and is made of a transparent conductive material. The pixel electrodes 114 are made of the same transparent conductive material. The transparent conductive material can, for example, be indium tin oxide (ITO) or indium zinc oxide (IZO). The alignment films 116, 126 are alignment layers for orientating the liquid crystal molecules. The color filter 112 comprises a black matrix (not shown), and a color resin layer having Red, Green and Blue segments. The black matrix is disposed between segments of the color resin layer, to prevent light beams from leaking.

The polarizers 142, 144 are both extraordinary type polarizers composed of mixtures of narrow-band components. Each component comprises a modified organic dye material which exists in a liquid-crystalline phase. Polarizing axes of the polarizers 142, 144 are perpendicular to each other; that is, the polarizers 142, 144 are crossed polarizers. The polarizers 142, 144 pass extraordinary polarized light beams, while blocking ordinary polarized light beams. A thickness of each of the polarizers 142, 144 is less than 100 microns. This ensures that the operating voltage of the COA-LCD 100 is not affected when the polarizers 142, 144 are formed at inner surfaces of the first substrate 110 and the second substrate 120, respectively.

When no voltage is applied to the common electrode 124 and the pixel electrodes 114, the liquid crystal molecules are oriented along directions according to the first and second alignment films 116 and 126. Long axes of the liquid crystal molecules at the first substrate 110 are oriented more than 90 degrees differently from long axes of the liquid crystal molecules at the second substrate 120. The state of polarization of light beams is changed when the light beams pass from the backlight module through the liquid crystal layer 130. Therefore, these light beams can pass through the polarizer 144 formed on the second substrate 120. As a result, the COA-LCD 100 is in a bright state.

When a voltage is applied to the common electrode 124 and the pixel electrodes 114, an electric field is produced therebetween at each pixel. The long axes of the liquid crystal molecules are oriented parallel to the electric field. Light beams from the backlight module pass through the liquid crystal layer 130. The state of polarization of the light beams does not change when they pass through the liquid crystal layer 130. Therefore the light beams cannot pass through the polarizer 144. As a result, the COA-LCD 100 is in a dark state.

Because of the extraordinary type polarizers 142, 144, the leakage of light beams through the pair of crossed polarizers 142, 144 is inversely proportional to the viewing angle. That is, light leakage at large viewing angles is reduced, and the polarizers 142, 144 provide a good contrast ratio over wide viewing angles. As a result, the display quality of the COA-LCD 100 is improved. In addition, the polarizers 142, 144 are positioned within the liquid crystal cell of the COA-LCD 100, and each polarizer 142, 144 has a thickness of less than 100 microns. Thus the COA-LCD 100 resists damage that might occur because of contamination or foreign matter, and is thin and compact. The COA-LCD 100 is ideal for use in a touch LCD panel, because only a touch layer needs to be positioned thereon. Furthermore, the polarizers 142, 144 are made of a modified organic dye material which exists in a liquid-crystalline phase. Therefore the COA-LCD 100 can work in temperatures less than 200 degrees Centigrade, and have a broader range of applications in the LCD marketplace.

Moreover, the color filter layer 112 is positioned on the first substrate 110 under the first polarizer 142. This arrangement reduces or eliminates the adverse effects of color filter de-polarizing, and yields a higher contrast ratio.

In manufacturing of the COA-LCD 100, first, a TFT substrate (corresponding to the first substrate 110) is formed. This includes the steps of: providing the first substrate made of glass or SiO₂; forming a thin film transistor array on the first substrate; forming a color filter layer on the first substrate, the color filter layer covering the thin film transistor array; coating an indium tin oxide layer on and partly covering an insulating layer of the color filter layer, with the indium tin oxide layer connecting to the thin film transistor array, thus forming a plurality of pixel electrodes on the color filter layer; coating a modified organic dye material layer, which exists in a liquid-crystalline phase, on the indium tin oxide layer, and controlling the layer to have a thickness of less than 100 microns, thus forming an extraordinary polarizer layer on the pixel electrodes; and rubbing an alignment film on the extraordinary polarizer layer.

Second, a common electrode substrate (corresponding to the second substrate 120) is formed. This includes steps of: providing the second substrate made of glass or SiO₂; coating an indium tin oxide layer on the second substrate, thus forming a common electrode on the second substrate; coating a modified organic dye material layer, which exists in a liquid-crystalline phase, on the indium tin oxide layer, and controlling the layer to have a thickness less than 100 microns, thus forming an extraordinary polarizer layer on the common electrode; and rubbing an alignment film on the extraordinary polarizer layer.

Third, the TFT substrate and the common electrode substrate are adhered together, thus forming a liquid crystal cell. Fourth and finally, liquid crystal is injected into the liquid crystal cell, thus obtaining the COA-LCD 100.

In a variation of the above-described manufacturing process, after the step of forming a color filter layer on the first substrate, the following alternative steps can be performed. A modified organic dye material layer is coated on the color filter layer, thus forming an extraordinary polarizer layer on the common electrode. Then an indium tin oxide layer is coated on the extraordinary polarizer layer, thus forming a plurality of pixel electrodes on the extraordinary polarizer layer. Finally, an alignment film is rubbed on the plurality of pixel electrodes. These alternative steps yield a COA-LCD similar to the COA-LCD 100, except that the positions of the first polarizer 142 and the pixels electrodes 114 are reversed.

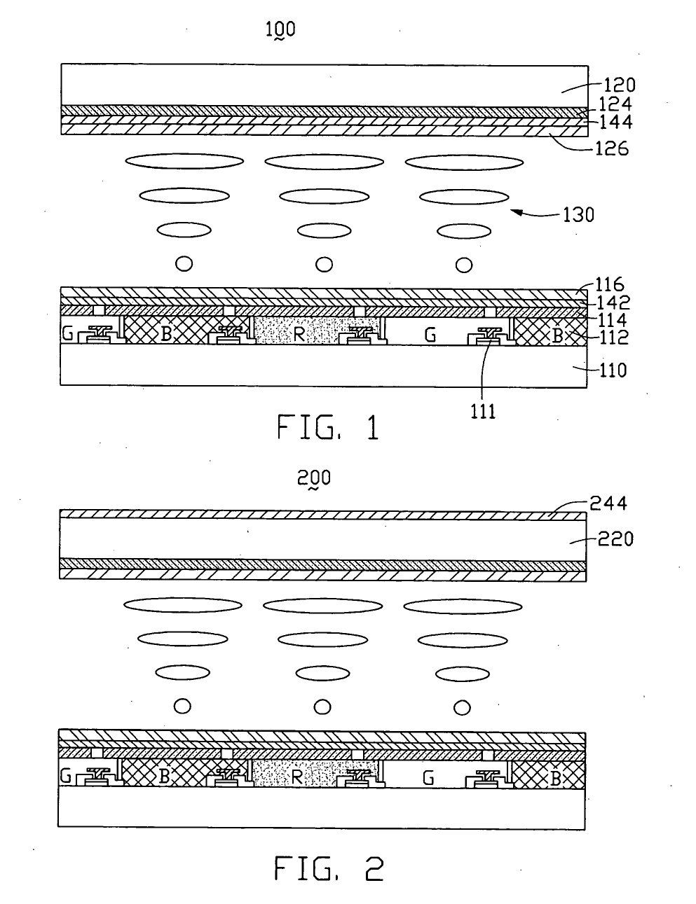

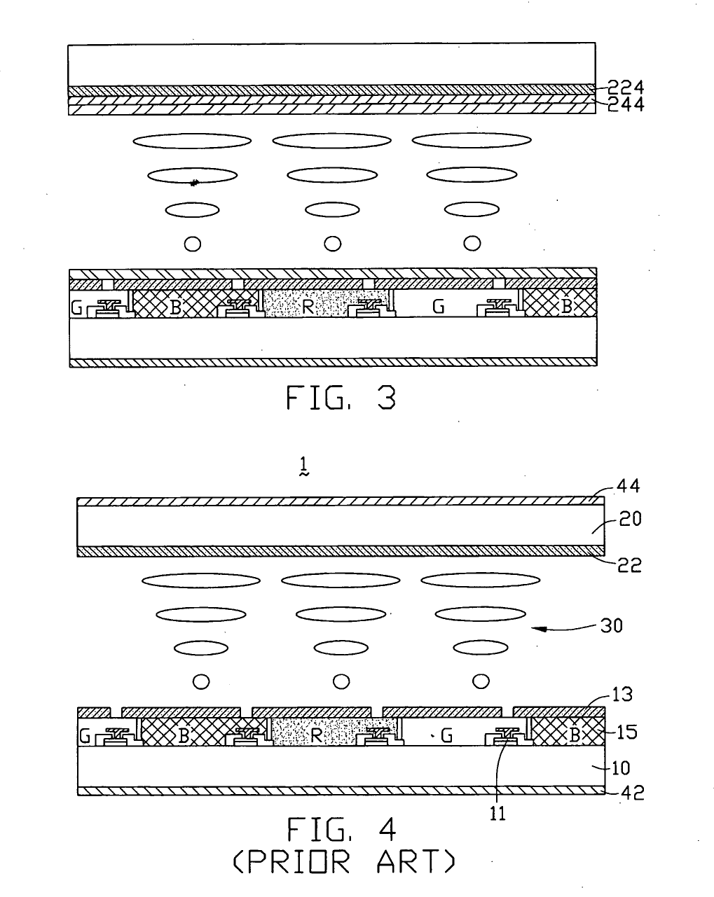

Referring to FIG. 2, a COA-LCD device 200 according to the second embodiment of the present invention is shown. An ordinary type polarizer 244 is positioned on an outer surface of a second substrate 220 (instead of having the extraordinary type polarizer 144 positioned on the inner surface of the common electrode 124 in the COA-LCD device 100). With this configuration, the COA-LCD device 200 can provide higher quality display images. In a variation of this configuration, the ordinary type polarizer 244 can be positioned on an inner surface of a common electrode 224 of the second substrate 220, as shown in FIG. 3.

It is to be further understood, however, that even though numerous characteristics and advantages of the present invention have been set out in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A color filter on array mode liquid crystal display, comprising:
a first substrate and a second substrate disposed opposite each other and spaced apart a predetermined distance;
a liquid crystal layer interposed between the first substrate and the second substrate;
a thin film transistor array, a color filter layer and a plurality of pixel electrodes formed on the first substrate;
a common electrode formed on the second substrate; and
a first polarizer and a second polarizer positioned at the first substrate and the second substrate, respectively;
wherein the first polarizer is an extraordinary type polarizer.

2. The liquid crystal display as claimed in claim 1, wherein the second polarizer is positioned on an inner surface of the second substrate.

3. The liquid crystal display as claimed in claim 2, wherein the second polarizer is an extraordinary type polarizer.

4. The liquid crystal display as claimed in claim 3, wherein each of the polarizers has a thickness of less than 100 microns.

5. The liquid crystal display as claimed in claim 3, wherein the first polarizer is positioned between the color filter layer and the pixel electrodes.

6. The liquid crystal display as claimed in claim 3, wherein the first polarizer is positioned on the pixel electrodes.

7. The liquid crystal display as claimed in claim 2, wherein the second polarizer is an ordinary type polarizer.

8. The liquid crystal display as claimed in claim 1, wherein polarizing axes of the first polarizer and the second polarizer are perpendicular to each other.

9. The liquid crystal display as claimed in claim 1, wherein the first polarizer is made of a modified organic dye material which exists in a liquid crystalline phase.

10. The liquid crystal display as claimed in claim 1, wherein the pixel electrodes and the common electrode are made of indium tin oxide.

11. The liquid crystal display as claimed in claim 1, wherein the pixel electrodes and the common electrode are made of indium zinc oxide.

12. A method for manufacturing a color filter on layer type liquid crystal display, comprising the steps of:
forming a thin film transistor substrate, which includes the sub-steps of: providing a first substrate; forming a thin film transistor array on the first substrate; forming a color filter layer on the first substrate, the color filter layer covering the thin film transistor array; coating an indium tin oxide layer on the color filter layer; coating an extraordinary type polarizer layer on the indium tin oxide layer; and rubbing an alignment film on the extraordinary type polarizer layer;
forming a common electrode substrate, which includes the sub-steps of: providing a second substrate; coating an indium tin oxide layer on the second substrate; coating a second polarizer layer on the indium tin oxide layer; and rubbing an alignment film on the second polarizer layer;
adhering the first and second substrates together, thereby forming a liquid crystal cell; and
filling liquid crystal molecules into the liquid crystal cell.

13. The method as claimed in claim 12, wherein the sub-step of coating the extraordinary type polarizer layer on the indium tin oxide layer is performed using a modified organic dye material, which exists in a liquid-crystalline phase.

14. The method as claimed in claim 12, wherein the extraordinary type polarizer layer is controlled to have a thickness of less than 100 microns.

15. A method for manufacturing a color filter on layer type liquid crystal display, comprising the steps of:
forming a thin film transistor substrate, which includes the sub-steps of: providing a first substrate; forming a thin film transistor array on the first substrate; forming a color filter layer on the first substrate, the color filter layer covering the thin film transistor array; coating an extraordinary type polarizer layer on the color filter layer; coating an indium tin oxide layer on the extraordinary type polarizer layer; and rubbing an alignment film on the indium tin oxide layer;
forming a common electrode substrate, which includes the sub-steps of: providing a second substrate; coating an indium tin oxide layer on the second substrate; coating a second polarizer layer on the indium tin oxide layer; and rubbing an alignment film on the second polarizer layer;
adhering the first and second substrates together, thereby forming a liquid crystal cell; and
filling liquid crystal molecules into the liquid crystal cell.

16. The method as claimed in claim 15, wherein the sub-step of coating the extraordinary type polarizer layer on the color filter layer is performed using a modified organic dye material, which exists in a liquid-crystalline phase.

17. The method as claimed in claim 15, wherein the extraordinary type polarizer layer is controlled to have a thickness of less than 100 microns.
